(19) United States
(12) Patent Application Publication
(10) Pub. No.: US 2023/0368545 A1
(43) Pub. Date: Nov. 16, 2023

(54) METHOD FOR PROCESSING IMAGES

(71) Applicant: CONTINENTAL AUTOMOTIVE GMBH, HANOVRE (DE)

(72) Inventors: Bertrand Godreau, Toulouse (FR); Sophie Rony, Toulouse (FR); Thibault Caron, Toulouse (FR); Bilal Hijazi, Toulouse (FR)

(21) Appl. No.: 18/029,515

(22) PCT Filed: Oct. 13, 2021
(86) PCT No.: PCT/EP2021/078342

§ 371 Date: Mar. 30, 2023

(30) Foreign Application Priority Data
Oct. 13, 2020 (FR) FR2010472

(51) Int. Cl. G06V 20/58; G06V 20/40; G06T 7/136; G06T 7/174; G06T 7/90; G06V 10/764

(52) U.S. Cl. CPC G06V 20/584; G06V 20/41; G06T 7/136; G06T 7/174; G06T 7/90; G06V 10/764; G06V 2201/08; G06T 2207/10024; G06T 2207/10016; G06T 2207/20021; G06T 2207/30252

(57) ABSTRACT

A method for processing a video stream of images captured by a color camera and used by a computer on board a motor vehicle to detect a priority vehicle, the method including: acquiring an image sequence; for each image of the image sequence: performing thresholding-based colorimetric segmentation, making it possible to detect colored luminous zones; tracking each segmented luminous zone; performing colorimetric classification of each segmented luminous zone; performing frequency analysis of each segmented luminous zone, making it possible to determine a flashing nature of the zone; computing an overall confidence index for each image of the image sequence, making it possible to declare a luminous zone as being a flashing light.

### CROSS REFERENCE TO RELATED APPLICATIONS

This application is the U.S. National Phase Application of PCT International Application No. PCT/EP2021/078342, filed Oct. 13, 2021, which claims priority to French Patent Application No. 2010472, filed Oct. 13, 2020, the contents of such applications being incorporated by reference herein.

### FIELD OF THE INVENTION

The present invention relates to an image processing method, in particular for detecting emergency vehicles.

### BACKGROUND OF THE INVENTION

Nowadays, it is known practice to equip a motor vehicle with a driving assistance system, commonly called ADAS (“Advanced Driver Assistance System”). Such a system comprises, as is known, an imaging device such as a camera mounted on the vehicle, which makes it possible to generate a series of images representing the environment of the vehicle. For example, a camera mounted at the rear of the vehicle makes it possible to film the environment behind the vehicle, and in particular following vehicles. These images are then used by a processing unit for the purpose of assisting the driver, for example by detecting an obstacle (pedestrians, stopped vehicle, objects on the road, etc.), or else by estimating the time to collision with the obstacles. The information given by the images acquired by the camera therefore has to be reliable and relevant enough to allow the system to assist the driver of the vehicle.

In particular, the majority of international legislation stipulates that a driver must not block the passage of priority vehicles in operation (also called emergency vehicles, such as fire engines, ambulances, police vehicles, etc.) and must make it easier for them to travel. It is thus appropriate for ADAS systems to be able to recognize such priority vehicles, all the more so when their lights (flashing lights) are activated, so as not to obstruct their call-out.

In current ADAS systems comprising a camera filming the front or rear of the vehicle, priority vehicles are detected in the same way as other standard (non-priority) vehicles. These systems generally implement a combination of machine learning approaches with geometric perception approaches. The images from these cameras are processed so as to extract bounding boxes around any type of vehicle (passenger cars, trucks, buses, motorcycles, etc.), including emergency vehicles, meaning that existing ADAS systems do not make it possible to reliably distinguish between a priority following vehicle and a standard following vehicle.

In addition, these systems are subject to problems with partial or total temporal concealment of the images acquired by the camera linked to the fact that a priority vehicle is not required to comply with conventional traffic rules and is allowed to zigzag between lanes, reduce safety distances or travel between two lanes, meaning that existing systems are not adapted for such behaviors and circumstances.

Again, it is difficult to detect priority vehicles or emergency vehicles because there is a large variety of types of priority vehicles. Indeed, these vehicles are characterized by their flashing lights, which are either LED-based or bulb-based, which may be either fixed or rotating, which are of different colors and have variable arrangements on the vehicle. For example, some vehicles are equipped with a single flashing light, others are equipped with pairs of flashing lights, yet others are equipped with bars comprising more than two flashing lights, etc. This variability problem makes it all the more difficult for existing ADAS systems to reliably detect priority vehicles.

This is exacerbated by detection problems for scenes also containing front headlights and tail lights of other vehicles and all other lights present in the environment behind the vehicle, and which may increase the difficulty in terms of detecting the flashing lights of priority vehicles.

### SUMMARY OF THE INVENTION

An aspect of the present invention therefore proposes an image processing method for quickly and reliably detecting priority vehicles regardless of the type of priority vehicle and regardless of the conditions in which it is traveling, in particular by detecting the lights (flashing lights) of these vehicles.

According to an aspect of the invention, this is achieved by virtue of a method for processing a video stream of images captured by at least one color camera on board a motor vehicle, said images being used by a computer on board said vehicle to detect a priority vehicle located in the environment of the vehicle, the at least one camera being oriented toward the rear of the vehicle, said method being characterized in that it comprises the following steps:
a step of acquiring an image sequence;
   for each image of the image sequence:
a step of performing thresholding-based colorimetric segmentation, making it possible to detect colored luminous zones of the image that are likely to be flashing lights;
a step of tracking each segmented luminous zone, according to which each luminous zone segmented in the segmentation step is associated with a prediction luminous zone of the same color;
a step of performing colorimetric classification, using a previously trained classifier, of each segmented luminous zone;
a step of performing frequency analysis of each segmented luminous zone, making it possible to determine a flashing nature of said segmented luminous zone;
a step of computing an overall confidence index for each image of the image sequence, making it possible to declare a segmented luminous zone as being a flashing light.

The method according to an aspect of the invention thus makes it possible to reliably detect the flashing lights of an emergency vehicle regardless of the brightness and weather conditions, and to do so up to a distance of 150 meters.

According to one exemplary embodiment, in the segmentation step, predefined segmentation thresholds are used so as to segment the luminous zones according to four categories:
the color red,
the color orange,
the color blue, and
the color violet.

According to one embodiment, after the segmentation step, the method furthermore comprises what is called a post-segmentation filtering step, making it possible to filter the results from the segmentation step, this post-segmentation step being carried out according to predetermined criteria regarding position and/or size and/or color and/or intensity. This filtering step makes it possible to reduce false detections.

According to one exemplary embodiment, the post-segmentation step comprises a dimensional filtering sub-step in which luminous zones located in parts of the image that are far from a horizon line and from a vanishing point and have a size less than a predetermined dimensional threshold are filtered. This step makes it possible to eliminate candidates corresponding to objects perceived by the camera that correspond to measurement noise.

According to one exemplary embodiment, the post-segmentation step comprises a sub-step of filtering luminous zones having a size greater than a predetermined dimensional threshold and a luminous intensity less than a predetermined luminous intensity threshold. This step makes it possible to eliminate candidates that, although they are close to the vehicle, do not have the luminous intensity required to be flashing lights.

According to one exemplary embodiment, the post-segmentation step comprises a positional filtering sub-step in which luminous zones positioned below a horizon line defined on the image of the image sequence are filtered. This step makes it possible to eliminate candidates corresponding to headlights of a following vehicle.

According to one embodiment, the post-segmentation step comprises, for a segmented luminous zone, a sub-step of performing oriented chromatic thresholding-based filtering. This specific filtering makes it possible to filter the colors more precisely. For example, for the color blue, to filter a large number of false positives in the detection of luminous zones classified as the color blue due to the fact that the white light emitted by the headlights of following vehicles may be perceived as being of the color blue by the camera.

According to one embodiment, the method furthermore comprises a second segmentation step, at the end of the tracking step, for each segmented luminous zone for which no association was found.

According to one exemplary embodiment, the second segmentation step comprises:
a first sub-step in which the segmentation thresholds are widened and the segmentation and tracking steps are repeated for each image of the image sequence with these new widened segmentation thresholds, the segmentation thresholds being those corresponding to the color of the segmented luminous zone, and
if, at the end of this first sub-step, no association has been found, a second sub-step in which the segmentation thresholds are modified so as to correspond to those of the color white.

This step makes it possible to confirm the luminous zones segmented (detected) in the segmentation. Indeed, this last check makes it possible to ensure that the false detection was actually a false detection, and that it was not a headlight of a following vehicle, for example.

According to one exemplary embodiment, in the frequency analysis step, a flashing frequency of each segmented luminous zone is compared with a first frequency threshold and with a second frequency threshold greater than the first frequency threshold, both thresholds being predetermined, a segmented luminous zone being filtered if:
its flashing frequency is less than the first frequency threshold, such that the segmented luminous zone is considered to be not flashing or weakly flashing, and therefore to not be a flashing light;
its flashing frequency is greater than the second frequency threshold, such that the segmented luminous zone is also considered to not be a flashing light.

According to one exemplary embodiment, the first frequency threshold is equal to 1 Hz and the second frequency threshold is equal to 5 Hz.

According to one exemplary embodiment, the method furthermore comprises a step of performing directional analysis of each segmented luminous zone, making it possible to determine a displacement of said segmented luminous zone.

According to one exemplary embodiment, a segmented luminous zone is filtered if the displacement direction obtained in the directional analysis step makes it possible to conclude as to:
immobilization of the segmented luminous zone, with respect to the vehicle;
moving away of the segmented luminous zone, with respect to the vehicle.

An aspect of the invention also relates to a computer program product comprising instructions for implementing a method comprising:
a step of acquiring an image sequence;
   for each image of the image sequence:
a step of performing thresholding-based colorimetric segmentation, making it possible to detect colored luminous zones of the image that are likely to be flashing lights;
a step of tracking each segmented luminous zone, according to which each luminous zone segmented in the segmentation step is associated with a prediction luminous zone of the same color;
a step of performing colorimetric classification, using a previously trained classifier, of each segmented luminous zone;
a step of performing frequency analysis of each segmented luminous zone, making it possible to determine a flashing nature of the segmented luminous zone;
a step of computing an overall confidence index for each image of the image sequence, making it possible to declare a luminous zone as being a flashing light, when it is implemented by a computer.

An aspect of the invention also relates to a vehicle, comprising at least one color camera oriented toward the rear of the vehicle and able to acquire a video stream of images of an environment behind the vehicle and at least one computer, the computer being configured to implement:
a step of acquiring a plurality of images;
   for each image of the image sequence:
a step of performing thresholding-based colorimetric segmentation, making it possible to detect colored luminous zones of the image that are likely to be flashing lights;
a step of tracking each segmented luminous zone, according to which each luminous zone segmented in the segmentation step is associated with a prediction luminous zone of the same color;
a step of performing colorimetric classification, using a previously trained classifier, of each segmented luminous zone;
a step of performing frequency analysis of each segmented luminous zone, making it possible to determine a flashing nature of the segmented luminous zone;
a step of computing an overall confidence index for each image of the image sequence, making it possible to declare a segmented luminous zone as being a flashing light.

### BRIEF DESCRIPTION OF THE DRAWINGS

Other features, details and advantages will become apparent from reading the following detailed description and from examining the appended drawings, in which:

FIG. 1 is a schematic depiction of a vehicle according to an aspect of the invention and a priority vehicle.

FIG. 2 shows one exemplary implementation of the method according to an aspect of the invention.

FIG. 3 illustrates one exemplary embodiment of the post-segmentation step of the method according to the invention.

FIG. 4 illustrates one exemplary embodiment of the second segmentation step of the method according to the invention.

FIG. 5A illustrates a first image of the image sequence processed by the method according to an aspect of the invention.

FIG. 5B illustrates a second image of the image sequence processed by the method according to an aspect of the invention.

FIG. 5C illustrates a third image of the image sequence processed by the method according to an aspect of the invention.

FIG. 6 illustrates a state machine in the form of hysteresis.

FIG. 7 illustrates another state machine in the form of hysteresis.

FIG. 8 illustrates a color space (U,V).

### DETAILED DESCRIPTION OF THE PREFERRED EMBODIMENTS

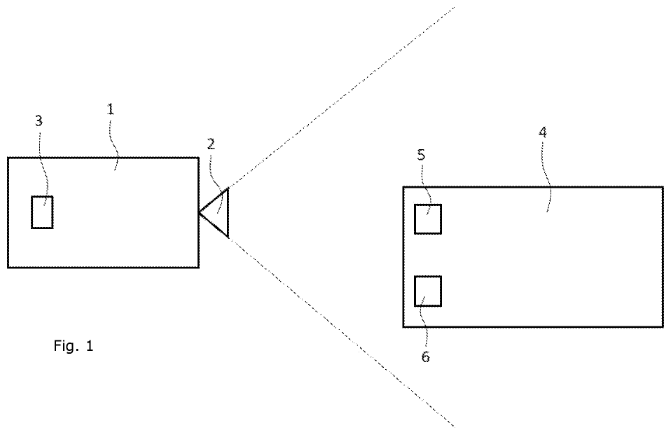

FIG. 1 schematically shows a vehicle 1 equipped with a color camera 2, oriented toward the rear of the vehicle 1 and able to acquire images of the environment behind the vehicle 1, and at least one computer 3 configured to use the images acquired by the camera 2. In this FIG. 1, an emergency vehicle, or priority vehicle, 4 is positioned behind the vehicle 1, in the field of view of the camera 2. It should be noted that this relative position between the vehicle 1 and the emergency vehicle 4 illustrated in FIG. 1 is in no way limiting.

A priority vehicle is characterized by luminous spots 5, 6, also called flashing lights, emitting in the blue, the red or the orange. These colors are used by priority vehicles in all countries. The priority vehicles may comprise one or more flashing lights, the arrangements of which may vary according to the number of flashing lights with which they are equipped (either a single flashing light or a pair of separate flashing lights that are spaced from one another, or a plurality of flashing lights that are aligned and close to one another), and the location of these flashing lights on the body of the priority vehicle (on the roof of the priority vehicle, on the front bumper of the priority vehicle, etc.). There are also many kinds of flashing lights. They may be LED-based or bulb-based.

Flashing lights of priority vehicles are also defined by their flashing nature, alternating between phases of being on and phases of being off.

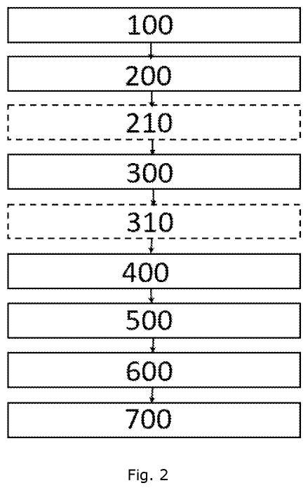

The method according to an aspect of the invention will now be described with reference to FIGS. 2 to 8.

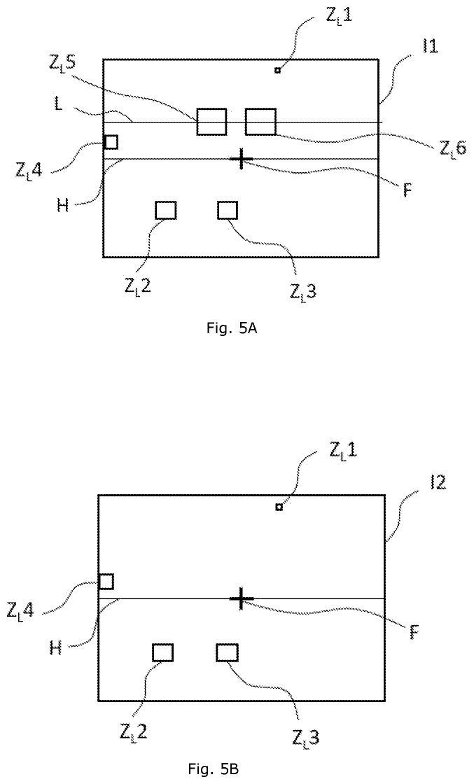

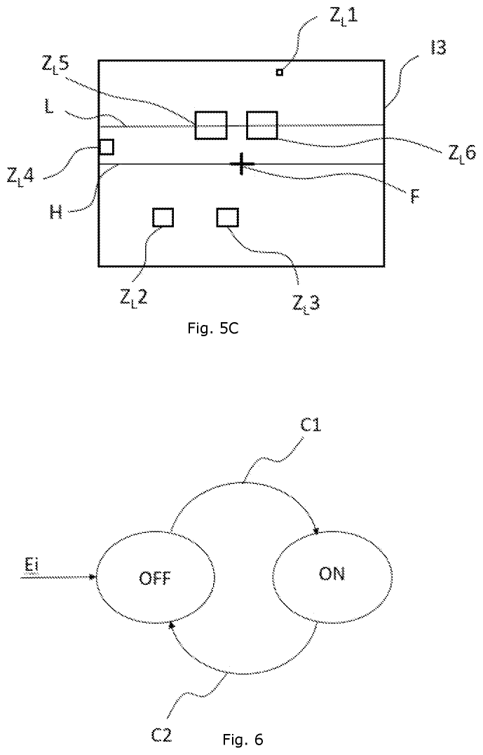

The method according to an aspect of the invention comprises a step 100 of acquiring an image sequence, comprising for example a first image I1, a second image I2, following the first image I1, and a third image I3 following the second image I2. Such images I1, I2 and I3 are shown in FIGS. 5A, 5B, and 5C, respectively.

The method according to an aspect of the invention comprises a step 200 of performing thresholding-based colorimetric segmentation.

This segmentation step 200 makes it possible, using predefined segmentation thresholds, to detect and segment luminous zones Z_{L}i in each image of the selection of images. This colorimetric segmentation is carried out according to four color categories:
the color red,
the color orange,
the color blue, and
the color violet.

The color violet is used in particular to detect certain specific flashing lights with a different chromaticity. For example, bulb-based flashing lights, perceived as being blue to the naked eye, may be perceived as being violet by cameras.

To adapt to the significant variability of flashing lights of priority vehicles, the thresholds used in the segmentation step 200 are extended with respect to thresholds conventionally used for the recognition of traffic lights, for example. These segmentation thresholds are predefined, for each color, for saturation, for luminous intensity, and for chrominance.

The segmentation step 200 gives the position in the image, the intensity and the color of the segmented luminous zones Z_{L}i of the emergency vehicle, when these are on.

As shown in FIG. 5A, at the end of the colorimetric segmentation step 200, a plurality of colored luminous zones Z_{L}1, Z_{L}2, Z_{L}3, Z_{L}4, Z_{L}5 and Z_{L}6 are detected in the first image I1, these being likely to be flashing lights of priority vehicles.

The extension of the threshold values used for the segmentation step makes it possible to adapt to the variability of flashing lights of priority vehicles in order to be sensitive to a greater range of color shades. However, this extension creates significant noise in the segmentation step 200.

To reduce the number of potential candidates for the detection of flashing lights of priority vehicles, in other words to reduce the number of false positives, the method according to an aspect of the invention comprises a post-segmentation step 210. This post-segmentation step 210 makes it possible to perform filtering based on predetermined criteria regarding position of the luminous zones Z_{L}i in the image under consideration, and/or size of the luminous zones Z_{L}i and/or color of the luminous zones Z_{L}i and/or intensity of the luminous zones Z_{L}i.

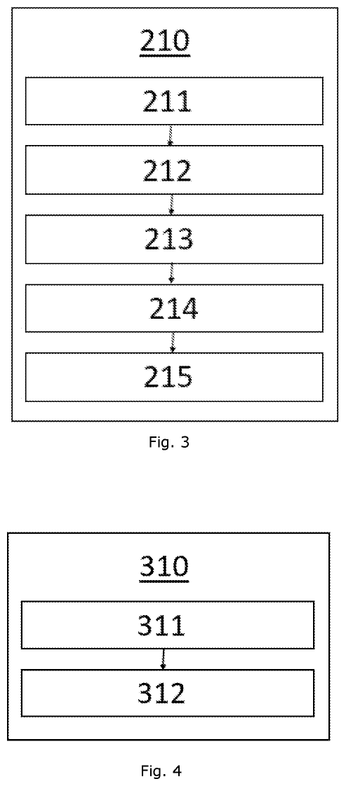

With reference to FIG. 3, the post-segmentation step 210 comprises a dimensional filtering sub-step 211 in which luminous zones Z_{L}i having a size less than a predetermined dimensional threshold, for example a size less than 20 pixels (said to be of small size), are filtered. This dimensional filtering is performed in particular in portions of the image that are distant from a horizon line H that represents infinity, and from a vanishing point F, specifically on the edges of the image. In other words, this filter makes it possible to remove luminous zones Z_{L}i of small size that are present in a portion of the image where it is not common to encounter luminous zones Z_{L}i of small size. Indeed, when luminous zones Z_{L}i of small sizes are present in an image, they correspond to lights that are far from the vehicle 1 when these luminous zones Z_{L}i are close to the horizon line H. Thus, a luminous zone Z_{L}i of small size that might not be close to the horizon line H would therefore not correspond to a light from the environment far from the vehicle 1 but to measurement noise, hence the benefit of filtering such a luminous zone Z_{L}i. This is therefore the case for the luminous zone Z_{L}1 illustrated in FIG. 5A.

Moreover, as mentioned previously, luminous zones corresponding to distant lights are located close to the horizon line H and to the vanishing point F of the image I1. Luminous zones located too far from this horizon line H and from this vanishing point F, in particular on the lateral edges of the image I1, are thereby also filtered when they have a size less than the predetermined dimensional threshold. This is therefore the case for the luminous zone Z_{L}4 illustrated in FIG. 5A.

The post-segmentation step 210 comprises a sub-step 212 of filtering luminous zones having a luminous intensity less a predetermined luminous intensity threshold, for example having a luminous intensity of less than 1000 lux, when these luminous zones Z_{L}i have a size greater than a predetermined threshold, for example a size greater than 40 pixels. Indeed, the luminous zones filtered in sub-step 212, although they have a size in the image corresponding to a proximity of the light with respect to the vehicle 1 in the rear scene filmed by the camera 2, they do not have the luminous intensity needed to be candidates of interest for being flashing lights of priority vehicles. A segmented luminous zone Z_{L}i of low intensity but close enough to the vehicle 1 to have what is called a large size in the image may for example correspond to a simple reflection of the sun's rays from a support.

The post-segmentation step 210 furthermore comprises a positional filtering sub-step 213 in which luminous zones positioned below the horizon line H are filtered. This is therefore the case for the luminous zone Z_{L}2 and Z_{L}3 illustrated in FIG. 5A. Indeed, such a position (below the horizon line H) of the luminous zones is characteristic of the front headlights of following vehicles in particular, and not of flashing lights of priority vehicles, which are positioned above the horizon line H.

The post-segmentation step 210 may also comprise a sub-step 214 of filtering conflicting luminous zones. At least two luminous zones are conflicting when they are close, intersect or if one is contained within the other. When such a conflict is observed, only one of these two luminous zones is retained, the other then being filtered. The luminous zone out of the two conflicting zones that is to be eliminated is determined, in a manner known per se, according to predetermined criteria regarding brightness, size and color of said zone.

The post-segmentation step 210 comprises, for a segmented luminous zone, a sub-step 215 of performing oriented chromatic thresholding-based filtering.

With reference to FIG. 8, a color space (U,V) between 0 and 255 is illustrated. Each color, R for red, V for violet, B for blue and O for orange, is determined in this color space according to threshold values Uₘₐₓ, Uₘᵢₙ, Vₘₐₓ, Vₘᵢₙ. For example, for the color blue, Uₘₐₓ(B), Uₘᵢₙ(B), Vₘₐₓ(B), Vₘᵢₙ(B).

This definition of colors by minimum and maximum values on the U and V axes creates rectangular color blocks that are not representative of reality and therefore not suitable. It is therefore necessary to carry out chromatic filtering for each color. Oriented chromatic thresholding-based filtering is tantamount to adjusting, for each color, the minimum and maximum values on the U and V axes of the color space of the color blocks. The risk of false detections due to the proximity of the color blocks (proximity of the U and V values between the colors in the color space (U,V)) is thus reduced. For example, it is sought, with this oriented chromatic filter, to filter colors of blue B that are too close to the color violet V, colors of red R that are too close to the color orange O, and so on.

This oriented chromatic filtering makes it possible to refine the definition of the colors and, therefore, to filter a large number of false positives in the detection of luminous zones.

Thus, after implementing the abovementioned sub-steps of the post-segmentation step 210, all that are retained as potential candidates for being flashing lights of priority vehicles are luminous zones Z_{L}i that are:
of a sufficiently large size (greater than 20 pixels);
positioned above the horizon line H;
luminous enough (luminous intensity greater than 1000 lux);
and the chromaticity of which is ensured (with suitable U and V values for avoid false positives).

It should be noted that all of the sub-steps are not always necessarily implemented in order to carry out the method according to an aspect of the invention, but that only some of them, alone or in combination, might be retained, on a case-by-case basis, depending on the complexity of the processed image.

Step 300 is a step of tracking each luminous zone ZLi detected in each image. In a manner known to those skilled in the art, an expected position of the luminous zones Z_{L}i segmented in the image in the segmentation step 200 is computed by the computer 3 and is used to ensure that a light detected in an image In indeed corresponds to one and the same segmented luminous zone in a previous image In−1 and that might have moved. The expected position of the luminous zones is determined using a prediction. The expected position of the segmented luminous zone in the current image In is computed based on the position of the luminous zone in the previous image In−1 plus a vector corresponding to the displacement of the luminous zone between the image In−2 and the image In−1, taking into account the displacement of the vehicle 1.

Moreover, as will be explained below, flashing lights of priority vehicles are in particular characterized by the flashing frequency of their flashing lights. Now, in order to be able to estimate the flashing frequency of the flashing flights, it is necessary to be able to estimate the evolution of their brightness (alternation of lighting phases and non-lighting phases) over time. The segmentation step 200 gives us the position in the image, the intensity and the color of these segmented luminous zones Z_{L}i only when these correspond to phases in which the flashing lights are on. The tracking step 300 makes it possible to associate the flashing lights from one image to another, and also to extrapolate their positions when they are in a non-lighting phase (off).

This tracking step 300, which is known from the prior art, has thresholds adapted to the flashing nature of the flashing lights and makes it possible in particular to associate the luminous zones of the flashing lights from one image to another image, and also to extrapolate their positions when the flashing lights are in an off phase (corresponding to an absence of a corresponding luminous zone in the image).

Each luminous zone Z_{L}i segmented in the segmentation step 200 is associated, in a manner known per se, with a prediction luminous zone Z_{P}i of the same color.

For each segmented luminous zone Z_{I}i for which no association was found with a prediction luminous zone Z_{P}i in the tracking step 300, a second segmentation step 310 is implemented, at the end of the tracking step 300.

This second segmentation step 310 comprises a first sub-step 311 in which the segmentation thresholds are widened (in other words, the segmentation thresholds are defined so as to be less strict, less filtering), and the segmentation step 200 and the tracking step 300 are repeated for each image of the image sequence, with these new widened segmentation thresholds. This step makes it possible to detect a segmented luminous zone Z_{L}i in a prediction segmentation zone Z_{P}i.

If, at the end of this first sub-step 311, still no association is found between the processed segmented luminous zone Z_{L}i and a prediction luminous zone Z_{P}i, a second sub-step 312 is implemented, in which the segmentation thresholds are modified so as to correspond to the color white. Indeed, this last check makes it possible to ensure that the false detection was actually a false detection, and that it was not a headlight of a following vehicle.

This second sub-step 312 makes it possible in particular to detect headlights of following vehicles whose white light may contain the color blue, for example.

The method according to an aspect of the invention then comprises a step 400 of performing colorimetric classification of each luminous zone Z_{L}i.

This classification step 400 makes it possible to select the luminous zones Z_{L}i resulting from the segmentation step 200. For each of the colors, a classifier is trained (in a prior what is called offline training step) to discriminate positive data (representative of flashing lights to be detected) from negative data (representative of all noise resulting from the segmentation step 200 that is not flashing lights and that it is therefore desirable not to detect, such as front headlights or tail lights of vehicles, reflections from the sun, traffic lights, etc.).

If, in the classification step, a segmented luminous zone Z_{L}i is not able to be classified (recognized) by the classifier, then this luminous zone is filtered.

On the other hand, if a luminous zone Z_{L}i is recognized by the classifier, it is retained as being a serious candidate for being a flashing light. At the end of the classification step 400, a list of candidate luminous zones Z_{C}i is obtained, these candidate luminous zones Z_{C}i being characterized by the following parameters:
a flashing state;
a classification confidence index I_{CC};
a position in the image;
a color.

The flashing status is obtained by detecting the flashing of the flashing lights. This detection consists in:
counting the number of images in which the flashing light is on and, therefore, in which the corresponding luminous zones Z_{L}5 and Z_{L}6 are detected (image I1 with reference to FIG. 5A),
counting the number of images in which the flashing light is off and, therefore, in which the corresponding luminous zones Z_{L}5 and Z_{L}6 are not detected (image I2 with reference to FIG. 5B), and
counting the number of images in which the flashing light is on again and, therefore, in which the corresponding luminous zones Z_{L}5 and Z_{L}6 are detected again (image I3 with reference to FIG. 5C).

The confidence index I_{CC} is obtained with the information in relation to flashing (flashing state) and positive classification by the classifier in step 400. According to one embodiment, after the classification step 400, the confidence index of each segmented luminous zone Z_{L}i is updated.

If the classification is positive, the classification confidence index I_{CC} for an image at a time t is updated with respect to a classification confidence index I_{CC} for an image at a time t−1 using the following formula:

Icc(t)=Icc(t−1)+FA [Math 1]

where FA is a predetermined increase factor.

If the classification is negative, the classification confidence index I_{CC} for an image at a time t is updated with respect to a classification confidence index I_{CC} for an image at a time t−1 using the following formula:

Icc(t)=Icc(t−1)−FR [Math 2]

where FR is a predetermined reduction factor.

The position and color information is for its part given by the classification step 200.

At the end of the classification step 400, in order to determine whether a candidate luminous zone Z_{C}i is likely to be a flashing light of an emergency vehicle, the method comprises a step of performing frequency analysis in order to compute and threshold the flashing frequency of the segmented luminous zone Z_{L}i and a step of computing a time integration of the classifier response. These steps are detailed below.

In a step 500, performing frequency analysis of each segmented luminous zone Z_{L}i makes it possible to determine a flashing or non-flashing nature of the segmented luminous zone Z_{L}i.

Advantageously, prior to this step 500, inconsistencies that the segmented luminous zones Z_{L}i could exhibit are corrected. In particular, this correction is carried out on the color, the size or else the intensity of the segmented luminous zones Z_{L}i. If an excessively great color fluctuation is detected, for example if the segmented luminous zone Z_{L}i changes from red to orange from one image to another, then said segmented luminous zone Z_{L}i is filtered. As another alternative, if the size of the segmented luminous zone Z_{L}i varies too much from one image to another (variation greater than two, for example), then said segmented luminous zone Z_{L}i is filtered.

Based on the detection of the on and off phases of the flashing light, making it possible to determine the flashing, a fast Fourier transformation (FFT), in a manner known per se, makes it possible to determine the frequency of this flashing.

In the frequency analysis step 500, this flashing frequency of each segmented luminous zone Z_{L}i is compared with a first frequency threshold S_{F}1 and with a second frequency threshold S_{F}2 greater than the first frequency threshold S_{F}1, both thresholds being predetermined. If the flashing frequency is less than the first frequency threshold S_{F}1, then the segmented luminous zone Z_{L}i is considered to not be flashing and therefore to not be a flashing light, and is filtered. If the flashing frequency is greater than the second frequency threshold S_{F}2, then the segmented luminous zone Z_{L}i is also considered to not be a flashing light, and is filtered.

This frequency analysis of the flashing makes it possible to filter segmented luminous zones Z_{L}i for which it is certain that they are constant or that they are flashing too slowly, or on the contrary, that they are flashing too fast, to be flashing lights of priority vehicles. Thus, all that are retained as being candidates of interest are segmented luminous zones Z_{L}i having a flashing frequency between the frequency thresholds S_{F}1 and S_{F}2.

According to one exemplary embodiment, the first frequency threshold S_{F}1 is equal to 1 Hz and the second frequency threshold S_{F}2 is equal to 5 Hz. Moreover, according to one example, the flashing lights fitted to police vehicles and emergency vehicles have a frequency typically between 60 and 240 FPM. FPM (abbreviation for flashes per minute) is a unit of measurement used to quantify the flashing frequency of a flashing light, corresponding to the number of cycles that occur in one minute. A value measured in FPM may be converted to hertz by dividing it by 60. In other words, for such priority vehicles, their frequency is between 1 Hz and 6 Hz.

These frequency threshold values S_{F}1 and S_{F}2 make it possible in particular:
to adapt to the camera (indeed, persistence of vision does not make it possible to see that certain lights are flashing, as is the case with lights on the roof of taxis, but the resolution of a camera is able to detect this);
to obtain a more robust result in the face of any errors in the segmentation step 200.
   In an optional step 600, directional analysis of each segmented luminous zone Z_{L}i is carried out in order to determine a displacement of said segmented luminous zone Z_{L}i with respect to the vehicle 1 by virtue of the tracking thereof in the image sequence acquired by the camera. Thus, if a segmented luminous zone Z_{L}i is moving away from the vehicle 1 (in other words, if the segmented luminous zone Z_{L}i is approaching the vanishing point F or the horizon line H in the image), then the segmented luminous zone Z_{L}i is filtered. This could also be the case if the segmented luminous zone Z_{L}i is immobile. This step makes it possible in particular to filter segmented luminous zones Z_{L}i that would effectively correspond to flashing lights, but of priority vehicles moving in a direction opposite to that of the vehicle 1, meaning that the vehicle 1 does not have to consider these priority vehicles. This step also makes it possible to filter the tail lights of cars traveling in a lane opposite to that of the vehicle 1.

This step makes it possible to improve the detection performance (true positives and false positives) in terms of detecting flashing lights of emergency vehicles by fusing the information relating to the segmented luminous zones Z_{L}i. Indeed, by studying the segmented luminous zones Z_{L}i as a whole (in all images of the image sequence) and not individually, it is possible to reduce the false positive rate while maintaining a satisfactory detection rate.

In this step of the method, a set of segmented luminous zones Z_{L}i are detected in the image of the image sequence. These detected segmented luminous zones Z_{L}i are stored in a memory of the computer 3 in the form of a list comprising an identifier associated with each segmented luminous zone Z_{L}i and also parameters of these segmented luminous zones Z_{L}i, such as:
their position in the image;
their size;
their color;
their intensity;
their flashing state;
the classification confidence index I_{CC} associated therewith.

In this step, all of the detected and retained segmented luminous zones Z_{L}i are considered to be potential flashing lights of emergency vehicles. In order to determine the presence or the absence of flashing lights of emergency vehicles in the scene (environment behind the vehicle corresponding to the image sequence acquired by the camera 2), the method finally comprises a step 700 of analyzing the scene, consisting in computing an overall confidence index I_{CG} for each image of the image sequence, for each of the colors red, orange, blue and violet. According to one exemplary embodiment, the overall confidence indices may be grouped by color. For example, the confidence index for the color violet is integrated with the confidence index for the color blue.

For this purpose, an instantaneous confidence index ID is computed in each image of the image sequence and for each of the colors red, orange, blue and violet.

The instantaneous confidence is computed based on the parameters of the segmented luminous zones Z_{L}i of the current image of the image sequence. Segmented luminous zones Z_{L}i with a flashing state and a sufficient classification confidence index I_{CC} are first taken into account.

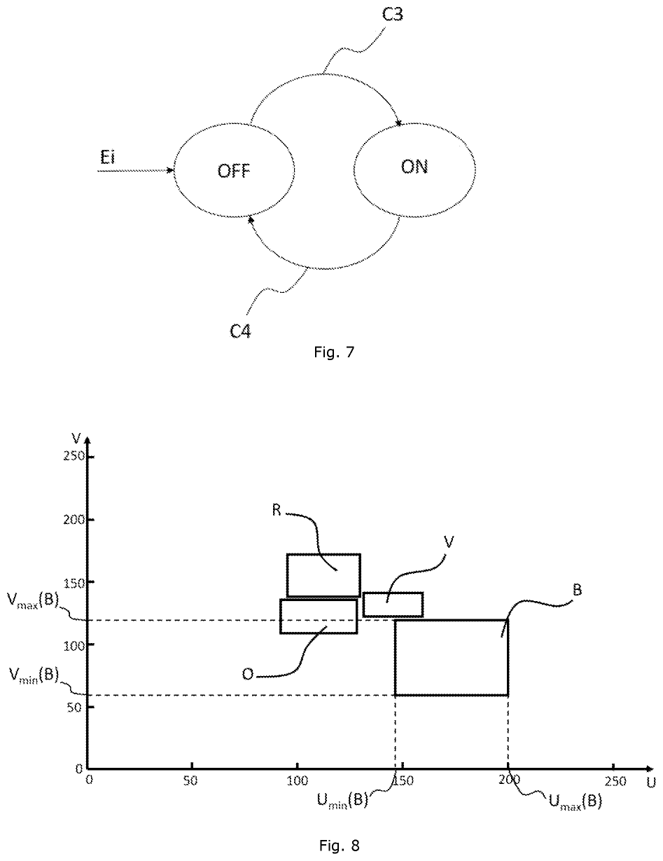

To determine segmented luminous zones Z_{L}i having a classification confidence index I_{CC} sufficient to be taken into account, a state machine in the form of hysteresis is illustrated in FIG. 7.

The state of the luminous zone Z_{L}i is initialized (Ei) in the state “OFF”:
the transition from the state “OFF” to the state “ON” taking place if the classification confidence index I_{CC} is greater than a predetermined threshold C3;
the transition from the state “ON” to the state “OFF” taking place if the classification confidence index I_{CC} is less than a predetermined threshold C4. One example of the computing of this instantaneous confidence index I_{CI} for an image and for a color could be the sum of the classification confidence indices I_{CC} of all segmented luminous zones Z_{L}i detected in the image of the image sequence, for this color. For example, for the color red:

Ici(Red(x2))=ΣIcc(Red(x2)) [Math 3]

This instantaneous confidence is then filtered over time in order to obtain an overall confidence index for each image of the image sequence and for each of the colors red, orange, blue and violet, using the following formula:

ICG(t)=(1−α)*ICG(t−1)+α*Ici [Math 4]
Ici being the instantaneous confidence index of the color under consideration;
α being a predetermined coefficient, associated with a color, and making it possible to determine the weight of the instantaneous confidence index Ici in the computing of the overall confidence index I_{CG}, for example, the value of the coefficient α is between 0 and 1, and preferably between 0.02 and 0.15.

The higher the value of the coefficient α, the greater the weight of the instantaneous confidence index Ici in the computing of the overall confidence index I_{CG}.

According to one exemplary embodiment, the coefficient α varies according to the parameters of the segmented luminous zones Z_{L}i. For example, the coefficient α is:
increased when multiple segmented luminous zones Z_{L}i have a classification confidence index I_{CC} greater than a predetermined threshold;
decreased when the computer 3 already indicates the presence of an emergency vehicle in the scene, thereby making it possible to stabilize and to bolster the result of the method in the event of momentary loss of detection in the detection chain of the segmented luminous zones ZLi, this momentary loss of detection possibly resulting for example from an occlusion, excessive brightness or excessive measurement noise.

According to one exemplary embodiment, the coefficient α varies as a function of the position of the segmented luminous zones Z_{L}i in the image. In particular, the coefficient α is:
decreased if the image comprises an isolated segmented luminous zone Z_{L}i positioned below the horizon line H (in other words, the integration speed will be low);
increased if a plurality of segmented luminous zones Z_{L}i are positioned above the horizon line H (this corresponding to a high integration speed).

According to one exemplary embodiment, the coefficient α varies as a function of the relative position of the segmented luminous zones Z_{L}i with respect to one another in the image. In particular, the coefficient α is increased if multiple segmented luminous zones Z_{L}i are aligned on one and the same line L.

The variations in the parameter a make it possible to adjust the sensitivity of the method and thus to detect the events more or less quickly depending on the parameters of the segmented luminous zones Z_{L}i.

It is also possible to assign a weight to each segmented luminous zone Z_{L}i of the current image of the image sequence that depends on the other parameters, for example:
the value of this weight is reduced if the segmented luminous zone Z_{L}i is of small size (in other words having a size less than 20 pixels for example) and/or close to the horizon line H;
the value of this weight is reduced if the segmented luminous zone is not very luminous (having for example a luminous intensity of less than 1000 lux);
the value of this weight is reduced if the color of the light is not clear (for example, in the case of saturated white light);
the value of this weight is increased if the segmented luminous zone Z_{L}i is close to other segmented luminous zones Z_{L}i that are similar (in terms of size, position, intensity, color).

This weight makes it possible to speed up the increase in the overall confidence index I_{CG} when multiple segmented luminous zones Z_{L}i have strongly correlated positions, brightnesses and colors. Slowing down the increase in the overall confidence index I_{CG} when the lights are of small size and of lower intensity makes it possible to reduce the false positive rate, although this leads to slower detection of distant emergency vehicles, this being acceptable.

Step 700 makes it possible to substantially reduce the detected false positive rate while still maintaining satisfactory detection rates for flashing lights of emergency vehicles.

At the end of step 700, it is possible, for the computer 3, to indicate the presence of an emergency vehicle in the environment behind the vehicle 1, corresponding to the image sequence acquired by the camera 2, and in particular to declare that a luminous zone Z_{L}i is a flashing light of an emergency vehicle, for example using a hysteresis threshold that is known per se.

A state machine in the form of hysteresis is illustrated in FIG. 6.

The state of the luminous zone Z_{L}i is initialized (Ei) in the state “OFF”:
the transition from the state “OFF” to the state “ON” taking place if the overall confidence index ICG is greater than a predetermined threshold C1;
the transition from the state “ON” to the state “OFF” taking place if the overall confidence index ICG is less than a predetermined threshold C2.

The vehicle (in the case of an autonomous vehicle), or the driver of the vehicle 1 otherwise, is then able to take the necessary measures to facilitate and not hinder the movement of said emergency vehicle.

1. A method for processing a video stream of images captured by at least one color camera on board a motor vehicle, said images being used by a computer on board said vehicle to detect a priority vehicle located in the environment of the vehicle, the at least one camera being oriented toward the rear of the vehicle, said method comprising:
acquiring an image sequence;
for each image of the image sequence:
performing thresholding-based colorimetric segmentation, making it possible to detect colored luminous zones of the image that are likely to be flashing lights;
tracking each segmented luminous zone, according to which each luminous zone segmented in the segmentation step is associated with a prediction luminous zone of the same color;
performing colorimetric classification, using a previously trained classifier, of each segmented luminous zone;
performing frequency analysis of each segmented luminous zone, making it possible to determine a flashing nature of said segmented zone; and
computing an overall confidence index for each image of the image sequence, making it possible to declare a segmented luminous zone as being a flashing light.

2. The method as claimed in claim 1, wherein, in the segmentation step, predefined segmentation thresholds are used so as to segment the luminous zones according to four categories:
the color red,
the color orange,
the color blue, and
the color violet.

3. The method as claimed in claim 1, wherein, after the segmentation step, the method furthermore comprises a post-segmentation filtering step, making it possible to filter the results from the segmentation step, this post-segmentation step being carried out according to predetermined criteria regarding position and/or size and/or color and/or intensity.

4. The method as claimed in claim 3, wherein the post-segmentation step comprises a dimensional filtering sub-step in which luminous zones located in parts of the image that are far from a horizon line and from a vanishing point and have a size less than a predetermined dimensional threshold are filtered.

5. The method as claimed in claim 3, wherein the post-segmentation step comprises a sub-step of filtering luminous zones having a size greater than a predetermined dimensional threshold and a luminous intensity less than a predetermined luminous intensity threshold.

6. The method as claimed in claim 3, wherein the post-segmentation step comprises a positional filtering sub-step in which luminous zones positioned below a horizon line defined on the image of the image sequence are filtered.

7. The method as claimed in claim 3, wherein the post-segmentation step comprises, for a segmented luminous zone, a sub-step of performing oriented chromatic thresholding-based filtering.

8. The method as claimed in claim 1, further comprising a second segmentation step, at the end of the tracking step, for each segmented luminous zone for which no association was found.

9. The method as claimed in claim 8, wherein the second segmentation step comprises:
a first sub-step in which the segmentation thresholds are widened and the segmentation and tracking steps are repeated for each image of the image sequence with these new widened segmentation thresholds, the segmentation thresholds being those corresponding to the color of the segmented luminous zone, and
if, at the end of this first sub-step, no association has been found, a second sub-step in which the segmentation thresholds are modified so as to correspond to those of the color white.

10. The method as claimed in claim 1, wherein, in the frequency analysis step, a flashing frequency of each segmented luminous zone is compared with a first frequency threshold and with a second frequency threshold greater than the first frequency threshold, both thresholds being predetermined, a segmented luminous zone being filtered if:
its flashing frequency is less than the first frequency threshold, such that the segmented luminous zone is considered to be not flashing or weakly flashing, and therefore to not be a flashing light;
its flashing frequency is greater than the second frequency threshold, such that the luminous zone is also considered to not be a flashing light.

11. The method as claimed in claim 10, wherein the first frequency threshold is equal to 1 Hz and the second frequency threshold is equal to 5 Hz.

12. The method as claimed in claim 1, further comprising performing directional analysis of each segmented luminous zone, making it possible to determine a displacement of said segmented luminous zone.

13. The method as claimed in claim 12, wherein a segmented luminous zone is filtered if the displacement direction obtained in the directional analysis step makes it possible to conclude as to:
immobilization of the segmented luminous zone, with respect to the vehicle;
moving away of the segmented luminous zone, with respect to the vehicle.

14. A non-transitory computer program product, comprising instructions for implementing a method comprising:
a step of acquiring an image sequence;
for each image of the image sequence:
performing thresholding-based colorimetric segmentation, making it possible to detect colored luminous zones of the image that are likely to be flashing lights;
tracking each segmented luminous zone, according to which each luminous zone segmented in the segmentation step is associated with a prediction luminous zone of the same color;
performing colorimetric classification, using a previously trained classifier, of each segmented luminous zone;
performing frequency analysis of each segmented luminous zone, making it possible to determine a flashing nature of the segmented luminous zone; and
computing an overall confidence index for each image of the image sequence, making it possible to declare a luminous zone as being a flashing light,
when it is implemented by a computer.

15. A vehicle, comprising at least one color camera oriented toward a rear of the vehicle and able to acquire a video stream of images of an environment behind the vehicle and at least one computer, the computer being configured to implement:
acquiring an image sequence;
for each image of the image sequence:
performing thresholding-based colorimetric segmentation, making it possible to detect colored luminous zones (Z_{L}i) of the image that are likely to be flashing lights (5, 6);
tracking each segmented luminous zone (Z_{L}i), according to which each luminous zone (Z_{L}i) segmented in the segmentation step (200) is associated with a prediction luminous zone (Z_{P}i) of the same color;
performing colorimetric classification, using a previously trained classifier, of each segmented luminous zone (Z_{L}i);
performing frequency analysis of each segmented luminous zone (Z_{L}i), making it possible to determine a flashing nature of the segmented luminous zone; and
computing an overall confidence index (I_{CG}) for each image of the image sequence, making it possible to declare a segmented luminous zone (Z_{L}i) as being a flashing light.

16. The method as claimed in claim 2, wherein, after the segmentation step, the method furthermore comprises a post-segmentation filtering step, making it possible to filter the results from the segmentation step, this post-segmentation step being carried out according to predetermined criteria regarding position and/or size and/or color and/or intensity.
